(19) United States
(12) Patent Application Publication
(10) Pub. No.: US 2007/0059238 A1
(43) Pub. Date: Mar. 15, 2007

(54) Process for enhancing yield of sodium aluminosilicate molecular sieves during synthesis

(76) Inventors: Ram Mohan Thakur, Mumbai (IN); Mohan Prabhu Kuvettu, Mumbai (IN); Biswanath Sarkar, Mumbai (IN); Venkatachalam Krishnan, Mumbai (IN); Mitra Bhanu Patel, Mumbai (IN); Sanjay Kumar Ray, Mumbai (IN); Gopal Ravichandran, Mumbai (IN); Satish Makhija, Mumbai (IN); Sobhan Ghosh, Mumbai (IN)

Correspondence Address: PAUL S MADAN;MADAN, MOSSMAN & SRIRAM, PC, 2603 AUGUSTA, SUITE 700, HOUSTON, TX, 77057-1130, US

(21) Appl. No.: 11/442,871

(22) Filed: May 30, 2006

Related U.S. Application Data
(63) Continuation-in-part of application No. 10/758,898, filed on Jan. 16, 2004, now abandoned.

(51) Int. Cl. C01B 39/00

(52) U.S. Cl. 423/700

(57) ABSTRACT

The present invention relates to a process for enhancing the yield of molecular sieve zeolite during the synthesis from a sodium aluminosilicate reaction mixture, said process comprising the step of adding at an intermediate stage of crystallization a source of aluminum to the sodium aluminosilicate reaction mixture and allowing the mixture to crystallize.

### CROSS REFERENCE TO RELATED APPLICATION

This application is a continuation-in-part of U.S. patent application Ser. No. 10/758,898 which was filed on Jan. 16, 2004.

### FIELD OF THE INVENTION

The present invention relates to a process for improving the yield of zeolite molecular sieves during synthesis. More particularly, the present invention relates to a process for improving the yield of zeolites during the synthesis by addition of a source of aluminum to an aluminum deficient reaction mixture. Addition of aluminum source at intermediate stage of crystallization promotes incorporation of unutilized silica species into zeolite framework, which otherwise is treated as waste in the mother liquor.

### BACKGROUND OF THE INVENTION

Crystalline sodium alumino silicate materials, which are able to distinguish molecules of slightly differing size and thus able to separate them from a mixture of gases are known as “molecular sieves” and quite often referred as “zeolites”. A number of synthetic crystalline zeolites have previously been prepared in the past. The most prominent and much exploited among them is zeolite Y. This zeolite is a synthetic analog of naturally occurring zeolite named faujasite, with respect to structure. Most of the zeolites are prepared by heating of sodium aluminosilicate precursor mixture to a crystallization temperature ranging from 45° C. to 180° C. for a period of 6 hours to 12 days. After the completion of crystallization, crystalline product is recovered by filtration. The liquor filtrate contains unutilized soda, silica, negligible alumina, salts and water and is referred to as “mother liquor”.

Prior-art work on zeolite Y is related to it's synthesis with different types of raw materials followed by improvement in silica to alumina ratio of the framework.

U.S. Pat. No. 2,882,243 awarded to Milton and U.S. Pat. No. 3,130,007 awarded to Breck describes a process for the synthesis of Y type zeolite in which aluminum and silicon salts used are soluble in aqueous medium.

In general, crystalline molecular sieves such as zeolite A, zeolite Y, zeolite X, mordenite, ZSM series zeolites are synthesized from a reaction mixture comprising soda, alumina and silica in an aqueous media under alkaline conditions. In the process of formation of molecular sieves, major amount of alumina is utilized and only part of soda and silica are consumed. Unutilized silica and soda present in the mother liquor were treated as waste. Improvement in the process for effective utilization or reuse of the mother liquor obtained after the synthesis of zeolite has drawn scanty attention. This mother liquor being unbalanced in composition permits only partial recycling for preparing a fresh batch of molecular sieves.

In some of the prior art processes for the manufacture of zeolite Y and X, partially acidic aluminum sulfate as an aluminum source is used. During the preparation of precursor gel, sodium sulfate byproduct is formed by the reaction between sodium hydroxide and soda of silicates with aluminum sulfate. This sodium sulphate byproduct is not consumed in building of zeolite framework and remains in the mother liquor and act as a hurdle even for partial recycling of mother liquor for preparing a fresh batch of molecular sieves.

U.S. Pat. No. 2,882,244 to Milton discloses the preparation of type X zeolite by a process, wherein it is suggested that the mother liquor may be reused after enrichment with proper amounts of reactants to give a properly proportioned reaction mixture.

U.S. Pat. Nos. 3,574,538 and 3,808,326 to McDaniel, U.S. Pat. No. 3,671,191 to Maher et al and U.S. Pat. No. 3,789,107 to Elliott disclose methods for preparing zeolites wherein zeolite nucleation centers are combined and reacted with sources of silica, alumina, sodium hydroxide and water.

U.S. Pat. No. 3,639,099 granted to Elliott, refers to a process for preparation of Y type zeolite from sodium aluminate and sodium silicate and effective utilization of raw materials. In this invention unreacted silica has been precipitated with a mineral acid and reused as a source of silica for further synthesis of molecular sieves.

U.S. Pat. No. 3,898,319 granted to Weber discloses a method for utilizing waste liquor obtained during synthesis of type Y zeolite, wherein the excess silicate present in the mother liquor is recovered as solid amorphous silica by precipitation with carbon dioxide. The precipitated silica is then reused to prepare additional type Y zeolite.

U.S. Pat. No. 3,939,246 teaches a process for crystallization of aluminosilicate zeolites of the molecular sieve type either as such or in aggregate combination with clay mineral accomplished by the addition of a flux constituting an alkali metal salt to a kaolin-type clay prior to calcination and caustic aging of said clay.

U.S. Pat. No. 4,016,246 teaches a process for preparing faujasite zeolite employing colloidal silica as a silica source.

U. S. Pat. No. 4,164,551 teaches a process for the preparation of type Y zeolite by reacting silica, alumina, sodium hydroxide and water to produce slurry of type Y zeolite and excess silicate containing mother liquor. Silicate is recovered from the mother liquor as precipitated silica/alumina hydrogel by the addition of an acid aluminum salt such as aluminum sulfate. The precipitated silica/alumina hydrogel is reused as a source of silica and alumina for preparing zeolite.

U.S. Pat. No. 4,175,059 teaches a process for preparing a synthetic faujasite having a novel platelet-type crystalline shape and silica to alumina ratio above 2.2 by adding potassium ions to seeded faujasite synthesis slurry and heating to convert to the synthetic faujasite. The use of the novel zeolite form as a catalyst promoter and an adjuvant for strengthening formed zeolite such as beads, balls, pills and extrudates is also disclosed.

U.S. Pat. No. 4,178,352 refers to a process for preparing type Y zeolite using a minimum excess of reactants by a method wherein required sodium hydroxide, silica, alumina and water reactants are combined in multi-stage procedure to obtain a uniform fluid reaction slurry.

Disposal of considerable quantities of silica, soda and sodium salts present in the mother liquor represents both a considerable economic waste and a burden to effluent treatment plant. Previous attempts to recycle the excess sodium silicate solution to a type Y zeolite synthesis process have not been particularly successful in that excess water and soda/sodium salts associated with the mother liquor tends to produce inferior or no zeolite product.

U.S. Pat. No. 4,228,137 relates to a process for an improvement in the production of zeolites, particularly, zeolites of the faujasite type, employing clay based seeds derived from natural halloysite.

U.S. Pat. No. 4,235,753 relates to an improved process for the production of mechanically strong shaped crystalline zeolite aluminosilicate bodies from precursor bodies composed of kaolin clay calcined at elevated temperature, the crystallized bodies having essentially the same size and shape as the precursor bodies.

U.S. Pat. No. 4,931,267 refers a faujasite polymorph having silica to alumina ratio greater than 6, and containing tetrapropyl ammonium and/or tetrabutyl ammonium trapped within the supercages of said structure.

U.S. Pat. No. 5,385,717 refers to the preparation of faujasite type structure from aluminosilicate gel containing a structuring agent ST.

U.S. Pat. No. 6,027,708 relates to a process for the production of fly ash based Zeolite-Y (FAZ-Y).

U.S. Pat. No. 6,284,218 refers to a process for the preparation of large crystallite size, highly crystalline faujasite type zeolite by heating a mixture of sodium aluminosilicate gel and seed. In this invention, said sodium aluminosilicate gel was prepared by reacting aluminum sulfate with a mixture of sodium silicate and sodium hydroxide.

U.S. Pat. No. 6,299,854 refers to a method of producing artificial zeolite, wherein heat treatment is performed in an alkali solution on a mixture obtained by adding at least one of cullets of glass waste, diatomaceous earth and aluminum dross to incineration ash of combustible waste.

In all the prior art processes for the preparation of faujasite type zeolite silica has been sourced from one of the raw materials such as sodium silicate, clays, colloidal silica, precipitated silica, gel silica, fumed silica including silicas such as those known by trade names as “Santocel”, “Cab-o-sil”, 'hi-Sil”, “QUSO” and “Ludox-AS 40”. While alumina has been sourced from aluminum salts such as sodium aluminate, aluminum sulfate, pseudoboehmite alumina, gel alumina, clays etc., depending upon sources chosen for silica and alumina, the required amount of soda in the form of sodium hydroxide has been taken.

It may be seen from the various examples for composition of reaction mixtures used in prior art processes for the synthesis of faujasite type zeolite, that soda has been used in moles ranging 2-14, while silica is used in moles ranging from, 3-50 on the basis of the use of one mole of alumina. Water content ranges from 100-1000 moles. This is true while synthesizing other types of zeolites such as A, X, clinoptilolite, mordenite etc., but composition may vary.

Similarly, from various examples sited in the prior art processes, composition of faujasite type zeolite has been expressed in moles, on volatile free basis as, 0.9-1.05 Na₂O, 1 Al₂O₃, 3.5-6 SiO₂

From various published literatures and from the yield pattern and composition for zeolites it can be seen that, alumina being highly active, major portion of this species present in the reaction mixture is consumed in the building of zeolite framework. It may be seen that, core portion of most of the zeolites is rich in alumina, while the surface is alumina deficient.

Further, it may be concluded that, as availability of alumina in the reaction mixture become scarce, zeolite stops growing. At this stage, crystallized product is recovered by filtration. Significant amount of silica and soda still remain in the mother liquor. If the crystallized product is not recovered by filtration new siliceous crystalline phase such as quartz or P type zeolite start growing in the silica rich mother liquor.

In example IV, of U.S. Pat. No. 3,130,007, composition of starting reaction mixture was:
9 Na₂O:Al₂O₃:12 SiO₂:314 H₂O.

The molar composition of crystallized product is:
0.92 Na₂O:Al₂O₃:3.29 SiO₂:7 H₂O.

From the above mentioned molar compositions for reaction mixture and zeolite, by assuming all the alumina present in the former is fully utilized, it can be concluded that, only 0.92 moles out of 9 moles of soda present in the reaction mixture is consumed. Similarly, 3.29 moles out of 12 moles of silica present in the reaction mixture are consumed. Mother liquor having unutilized soda and silica is sent to effluent treatment plant, thus causing economic loss.

Similarly, in example 2 of U.S. Pat. No. 6,284,218, the molar composition of reaction mixture has been worked out as:
3.94 Na₂O:2.85 Na₂SO₄:Al₂O₃:10.92 SiO₂:188.89 H₂O.

While the composition of zeolite on anhydrous basis is:
Na₂O:Al₂O₃:5.8 SiO₂.

With the assumption, all the alumina has been utilized in the reaction, composition of mother liquor on anhydrous basis, after the recovery of zeolite has been worked out as:
2.94 Na₂O:2.85 Na₂SO₄:5.12 SiO₂.

Since there is no new process for further utilization of 2.94 moles of Na₂O, 5.12 moles of SiO₂ in the further growth of zeolite the same is being sent to effluent treatment plant as a waste material or at the best part of mother liquor may be recycled for the new batch. If unutilized silica is recovered employing some of processes discussed in prior art processes for reutilization, the process won't be economical.

Looking at the valuable amount of silica and soda present in the mother liquor and the same being sent to effluent treatment plant as referred to in the prior art citation and also the cost of recovery of silica for further utilization it is thought worth to utilize unreacted silica and soda for further continued crystallization by making up for deficiency in unreacted raw material in the same run.

### OBJECTS OF THE INVENTION

The prime object of the present invention is to provide a process for improving the yield of molecular sieve zeolite during synthesis.

Another object of the present invention is to provide a method by which unutilized silica and soda present in the zeolite synthesis reaction mixture is efficiently converted into a crystalline zeolite product thereby increasing the yield of final crystalline product with appropriate making up for deficiency in composition.

Yet another objective of the present invention is to provide a process by which load on effluent treatment plant is reduced.

### STATEMENT OF THE INVENTION

Accordingly, the present invention provides a process for improving the yield of molecular sieve zeolite during the synthesis. More particularly, the present invention provides an improved process for efficiently utilizing un-reacted silica and soda present in a molecular sieve zeolite synthesis mixture for preparing molecular sieve zeolite product, thereby increasing the yield of the zeolite produced from a reaction mixture containing certain amount of silica and soda.

### DETAILED DESCRIPTION OF THE PRESENT INVENTION

Accordingly, the present invention provides a process for efficiently converting unreacted silica and soda into a crystalline silica-alumina zeolite framework. Broadly, the present invention contemplates a process for improving the utilization of silica and soda present in the zeolite crystallization mixture.

Accordingly, the present invention provides a process for enhancing the yield of molecular sieve zeolite during the synthesis from a sodium aluminosilicate reaction mixture, said process comprising the step of adding at an intermediate stage of crystallization a source of aluminum and an acid to the sodium aluminosilicate reaction mixture and allowing the mixture to crystallize, wherein the adding of the source of aluminum serves to make up for the aluminum deficiency arising in the sodium aluminosilicate reaction mixture during crystallization.

In an embodiment of the present invention, the source of aluminum is added to the sodium aluminosilicate reaction mixture over an extended period of time.

In another embodiment of the present invention, the source of aluminum is added to the sodium aluminosilicate reaction mixture in a dilute form.

In yet another embodiment of the present invention, alumina is present in the ionic form in the source of alumina.

In still another embodiment of the present invention, the source of aluminum is added to the sodium aluminosilicate reaction mixture under constant agitation.

In one more embodiment of the present invention, the sodium aluminosilicate reaction mixture is depleted of aluminum and enriched in un-reacted soda and silica at the intermediate stage of crystallization.

In one another embodiment of the present invention, the intermediate stage of crystallization at which aluminum source and the acid is added occurs in the range of 0.5 hour to 48 hours.

In a further embodiment of the present invention, the molecular sieve zeolite obtained is selected from the group consisting of low silica to alumina ratio zeolite, a medium silica to alumina ratio zeolite and a high silica to alumina ratio zeolite.

In a further more embodiment of the present invention, the molecular sieve zeolite obtained is selected from zeolite Y, X, A, ZSM-5, ZSM-11, Beta, Omega, climnoptilote and Mordenite.

In an embodiment of the present invention, the source of aluminum is selected from the group consisting of aluminum salts, bayerite, pseudoboehmite, alumina gel and alumina sol and the acid is selected from the group consisting of sulfuric acid, nitric acid, hydrochloric acid, hydrofluoric acid, formic acid, acetic acid, citric acid, and oxalic acid.

In another embodiment of the present invention, the aluminum salt is selected from the group consisting of aluminum sulfate, sodium aluminate, aluminum oxalate, aluminum formate, and aluminum trihydrate.

More particularly, the present invention provides a process for enhancing yield of molecular sieve zeolite during synthesis from a sodium aluminosilicate reaction mixture, said process comprising steps of:
(a) preparing a sodium aluminosilicate seed mixture;
(b) preparing a sodium aluminosilicate gel reaction mixture;
(c) adding the seed mixture of step (a) to the gel reaction mixture of step (b) to obtain molecular sieve precursor mixture;
(d) heating the molecular sieve precursor mixture to a temperature sufficient for crystallization to occur;
(e) adding a source of aluminum and an acid to the molecular sieve precursor mixture at an intermediate stage of crystallization, wherein the molecular sieve precursor mixture is depleted of aluminum and enriched in soda and silica at the intermediate stage wherein the adding of the source of aluminum serves to make up for the aluminum deficiency arising in the molecular sieve precursor mixture during crystallization, and
(f) crystallizing molecular sieve zeolite product, recovering of crystallized product by filtration; washing the same with hot demineralised water to obtain molecular sieve zeolite with pH below 9.

In an embodiment of the present invention, the molecular sieves are selected from the group consisting of zeolite A, X, Y, Mordenite, Beta, Omega, climnoptilote , ZSM-5 and those having sodium aluminosilicate framework can be enhanced by addition of aluminum source and an acid during intermediate stage of crystallization.

In another embodiment of the present invention, the precursor gel mixture has wide range of composition expressed in the molar ratio as:
0.5-15 Na₂O:Al₂O₃:1-200 SiO₂:50-1000 H₂O.

In yet another embodiment of the present invention, the crystallizing molecular sieve zeolite product occurs in from 24 hrs to 120 hrs.

In still another embodiment of the present invention, the crystallizing molecular sieve zeolite product occurs at a temperature that varies from 45 to 180° C.

In one more embodiment of the present invention, the source of aluminum is selected from group consisting of aluminum sulfate, sodium aluminate, aluminum oxalate, aluminum formate, aluminum trihydrate, colloidal alumina and alumina gel.

In one another embodiment of the present invention, the quantity of aluminum compound added at intermediate stage of crystallization is in the range of 0.5 to 25 wt % expressed as Al₂O₃ on the basis of total silica (SiO₂) present in the precursor gel mixture.

In a further embodiment of the present invention, the acid used is selected from the group consisting of sulfuric acid, nitric acid, hydrochloric acid, hydrofluoric acid, formic acid, acetic acid, citric acid, and oxalic acid.

During the process of crystallization of zeolite aluminum present in the reaction mixture is constantly consumed and after a predetermined period of time an aluminum deficient reaction mixture is formed and according to the present invention, a pre-calculated amount of source of aluminum is added to the aluminum deficient reaction mixture thus formed thereby efficiently increasing the yield of zeolite. Addition of predetermined amount of aluminum source after a predetermined period of time helps in the conversion of unutilized silica into zeolite. Aluminum source used may be selected from aluminum sulfate, sodium aluminate, aluminum acetate, aluminum formate. Besides aluminum salts, other sources of alumina such as bayerite, pseudoboehmite, alumina gel or alumina sol may also be utilized.

The new found process is not only useful for improving the efficiency of conversion of silica employed in a zeolite reaction mixture but also, improves the quality of final product.

The present invention can also be employed for improving the yields of varieties of zeolites such as Y, X, A, ZSM-5, ZSM-11, Beta, mordenite to name a few.

The invention is further explained with the help of the following examples which are given by way of illustration and should not be construed to limit the scope of the invention.

### EXAMPLE 1

### Preparing Seed Solution

The example illustrates the process of preparing seed solution which can act as nucleation centers. 118 grams of sodium silicate (16.4% Na₂O, 35.60% SiO₂, 48.0% H₂O) was diluted with 110 grams of demineralized (DM) water. To this, a solution containing 11 grams sodium aluminate (24.23% Na₂O, 43.93% Al₂O₃, 31.84% H₂O) dissolved in 88 grams of DM water and 28.14 grams sodium hydroxide (77.5% Na₂O, 22.5% H₂O) were added drop wise with stirring. Stirring continued for 5 minutes. The mixture was aged for 18 hours at 35° C. At the end the slurry was ready for use as a seed solution.

### EXAMPLE 2

### Preparing Faujasite Type Zeolite

The present example illustrates the process of preparing faujasite type zeolite similar to the procedure given in U.S. Pat. No. 6,284,218. 1590 grams of sodium silicate (16.4% Na₂O, 35.60% SiO₂, 48.0% H₂O) was diluted with 400 grams of DM water. To this, sodium hydroxide solution prepared by dissolving 112 grams sodium hydroxide pellets (77.5% Na₂O, 22.5% H₂O) in 350 grams of DM water was added under stirring. A solution containing 555 grams hydrated aluminum sulfate [Al₂(SO₄)₃, 16 H₂O (16.17% Al₂O₃)] dissolved in 1100 grams of DM water was added drop wise to the sodium silicate-alkali solution with constant stirring. To this mixture, the seed solution as prepared in Example 1 was added slowly with stirring. Final pH of the silica-alumina gel-seed mixture was measured as 12.3. The mixture was held at 100° C. for 23 hours in a boiling water bath. Crystallized product was filtered out while, mother liquor was stored. The product was washed with boiling DM water till the pH of the filtrate came down to 9, and then dried at 110° C. for 16 hours. 531 grams of oven dried product was obtained having 12 wt % moisture.

The crystallinity of the product was 99% with unit cell size (UCS) 24.67 Å, surface area 650 m²/g.

Particle size distribution for the obtained product was measured employing laser particle sizer, which showed that the average particle size of (APS) of the product thus obtained to be about 3 microns. Further investigation was carried out on the product thus obtained using Scanning Electron Micrographs which revealed the product to have clear octahedral morphology for zeolite crystals and size between 1 micron to 5 micron.

### EXAMPLE 3

### Process of Increasing the Yield of Zeolite

The example illustrates the procedure for increasing the yield of final crystalline product. Zeolite precursor slurry containing silica-alumina gel and seed was prepared as per procedure explained under example 2. This precursor slurry was subjected to crystallization in a water bath maintained at 100° C. In parallel 333 grams of sodium aluminate solution having a composition of 17.53 wt % Na₂O, 14.48 wt % Al₂O₃, and 67.98 wt % H₂O was prepared. After 12 hrs crystallization, this sodium aluminate solution was added drop wise to the zeolite reaction mixture in 6 hours duration while resulting mixture was kept under stirring. Final reaction mixture pH was measured as 12.5. After 23 hours crystallization crystallized product was filtered out, washed with boiling DM water till the pH of the filtrate came down to 9, and then dried at 110° C. for 16 hours. Oven dried product was weighed as 636 grams having 12 wt % moisture.

The crystallinity of the product was 98% with unit cell size (UCS) 24.67 Å, surface area 650 m²/g. In this example zeolite yield has increased by 19.8 wt % on volatile free basis compared to yield under example 2 which is a reference batch. Zeolite product obtained under this example 3 where yield was enhanced by 19.8% has an average particle size of 4 microns. Scanning electron micrographs showed zeolite particles in the range 2-6 microns with octahedral morphology.

### EXAMPLE 4

### Effect of Faster Addition of Sodium Aluminate While Enhancing Yield of Faujasite Zeolite

The above experiment was repeated with addition of 333 grams of sodium aluminate solution having a composition of 17.53 wt % Na₂O, 14.48 wt % Al₂O₃, and 67.98 wt % H₂O in 30 minutes. The product obtained was recovered and washed with procedure explained earlier. By fast addition of sodium aluminate, faujasite phase percent decreased to 60% and significant quantity of zeolite X formed having lower silica alumina ration. Thus this example demonstrates that addition of sodium aluminate should be performed in a slower rate to sustain the required silica alumina ration in the reaction mixture and also to enhance zeolite faujasite phase in the final product.

### EXAMPLE 5

### Process of Increasing the yield of Zeolite Employing a Mineral Acid and Sodium Aluminate

In this example procedure for increasing the yield of final crystalline product by use of a mineral acid and a source of aluminum is explained.

Zeolite precursor slurry containing silica-alumina gel and seed was prepared and put for crystallization as per procedure explained under example 2. In parallel 333 grams of sodium aluminate solution having a composition of 17.53 wt % Na₂O, 14.48 wt % Al₂O₃, and 67.98 wt % H₂O was prepared. After 12 hrs crystallization period, sodium aluminate solution and 246 grams of 20 wt % dilute sulfuric acid were added drop wise to the zeolite reaction mixture in 6 hours duration while resulting mixture was kept under stirring. Final reaction mixture pH was measured as 12.0. At the end of 23 hours crystallized product was filtered out, washed with boiling DM water till the pH of the filtrate came down to 9, and then dried at 110° C. for 16 hours. Oven dried product was weighed as 698 grams having 12 wt % moisture. Zeolite yield has been found increased by 31.53 wt % compared to yield under example 2 which is reference zeolite.

The crystallinity of the product was 90% with unit cell size (UCS) 24.67 Å, surface area 590 m²/g.

### EXAMPLE 6

### Preparation of Zeolite A

Preparation of Seed Solution

Seed solution was prepared 16 hours before the make-up of the synthesis gel to allow time for “aging”. 35 g of neutral grade sodium silicate solution (having a composition 285 wt % SiO₂ and 8.5 wt % Na₂O) was added to a container together with 24.1 grams of DM water and 18 grams of caustic solution (containing 38.8 wt % Na₂O). 4.9 grams of a separately prepared sodium aluminate solution (23.3% Al₂O₃; 19.8% Na₂O) at ambient temperature was slowly added to the dilute silicate with intensive mixing to minimize gel formation. Reagents were mixed in the container at ambient temperature by means of a portable stirrer. After mixing the seed gel was set aside to age for 16 hours.

Silica Alumina Gel Preparation and Synthesis of Zeolite A

The sodium aluminate solution was prepared by reacting aluminum trihydrate with caustic solution. To prepare this solution a 1 liter steel vessel was charged with 102 grams caustic (38.8 wt % Na₂O) solution. 38 grams of alumina trihydrate (Al₂O₃ 45 wt %) was added to caustic solution. The vessel was then heated to 98-100° C. This temperature was maintained with mixing for about 1 hour to ensure complete digestion of alumina. 300 grams of DM water was then added and the solution was cooled to 34° C.

240 grams of alkaline grade sodium silicate solution (with an oxide composition of 35.6 wt % SiO₂, 16.4 wt % Na₂O , 48 wt % H₂O.) was added to a crystallizer vessel of about 2 liter capacity. The sodium aluminate solution prepared as above was added to the silicate solution in the crystallizer vessel at a controlled rate, without heating, over a period of about 40 minutes while the resulting mixture was stirred. When the addition of the aluminate solution was complete, 18 grams of alumina trihydrate (45% Al₂O₃) was added to the gel slurry. Finally, 40 grams of the aged seed solution was added to the crystallizer slurry. The gel mixture was then heated to 90-93° C. in a water bath. After reaching the desired temperature in approximately 40 minutes the batch was maintained at that temperature for 2 hours. Crystallized product was recovered by filtration and was washed with adequate boiling DM water. Washed product was dried in air oven at 120° C. It was weighed as 72.5 grams with moisture content of 10 wt % and shown to have 90% X-ray crystallinity with respect to a standard sample. Surface area was measured as 650 m²/gm.

Enhancement of Zeolite Yield

The above experiment was repeated and one hour after initiating crystallization, 35 grams of sodium aluminate (composition, 23.3 wt % Al₂O₃; 19.8 wt % Na₂O) was added in 15 minutes under mild stirring. At the end crystallized product was recovered by filtration, washed and dried. Weight of the product was 94.9 grams, thus increase of 30 grams in yield. Crystallinity was measured as 89%. Surface area was 630 m²/gm.

### EXAMPLE 7

### Process the Synthesis of Mordenite Zeolite

Aqueous solutions of 159 grams of caustic (38.8 wt % Na₂O), 28.42 grams of sodium aluminate (23.3 wt % Al₂O₃; 19.8 wt % Na₂O), 450 grams of tetrapropyl ammonium bromide (TPABr) and 410 grams of colloidal silica (40 wt % SiO₂) were weighed in to separate beakers. To the beaker containing TPABr other solutions were added in the order caustic solution, sodium aluminate and colloidal silica. While they were being added, the mixture was stirred vigorously. The final reaction mixture having molar composition 10.65 Na₂O, Al₂O₃, 29.3 SiO₂, 10.5 TPABr, 1477 H₂O expressed in moles, further pH adjusted to 11 with dilute sulfuric acid was heated to 150° C. in a Teflon lined Berghof autoclave for 7 days. At the end crystallized product was recovered by filtration, washed repeatedly with boiling DM water and dried in air over at 120° C. The product was weighed as 119 grams having moisture and organic matter 24 wt %. Surface area was measured as 302 m²/gm and crystallinity of 90%.

Enhancement of Zeolite Yield

The above experiment was repeated by adding 8 grams of sodium aluminate (having composition 23.3 wt % Al₂O₃; 19.8 wt % Na₂O) after 3 days of crystallization. Addition was performed in small pulses over 24 hrs duration with a high pressure device. At the end crystallized product was recovered by filtration, washed with boiling DM water and oven dried at 120° C. Dry product was weighed as 142 grams having 24 wt % moisture and volatile matter. Surface area was measured as 299 m²/gm and crystallinity of 90%.

### EXAMPLE 8

### Study to Show Addition of only Mineral Acid Decreases the Yield of Zeolite and pH Has to be Controlled

This particular example demonstrates importance of pH control and any lowering of pH will affect zeolite yield.

Zeolite precursor slurry containing silica-alumina gel and seed was prepared and put for crystallization as per procedure explained under example 2. After 12 hours crystallization period 10 wt % sulfuric acid was added drop wise till the pH of resulting mixture decreased to 11.5. At the end of 23 hours crystallized product was filtered out, washed with boiling DM water till the pH of the filtrate came down to 9. Washed product was dried at 110° C. for 16 hours. Oven dried product was weighed as 481 grams having 12 wt % moisture thus the yield lower by 9.4 wt % compared to reference zeolite of example 2.

The crystallinity of the product was 96% with unit cell size (UCS) 24.67 Å, surface area 615 m²/g.

### EXAMPLE 9

### Study to Show Addition of only Soda Lye Decreases the Yield of Zeolite and pH Has to be Controlled

This particular example demonstrates importance of pH control and any increase in pH of reaction mixture will affect zeolite yield.

Zeolite precursor slurry containing silica-alumina gel and seed was prepared and put for crystallization as per procedure explained under example 2. After 12 hours crystallization period a soda lye having Na₂O 12 wt % was added drop wise till the pH of resulting mixture increased to 12.8. At the end of 23 hours crystallized product was filtered out, washed with boiling DM water till the pH of the filtrate came down to 9, and then dried at 110° C. for 16 hours. Oven dried product was weighed as 400 grams having 12 wt % moisture. This yield is lower by 24.6 wt % compared to reference zeolite of example 2.

The crystallinity of the product was 98% with unit cell size (UCS) 24.67 Å, surface area 630 m²/g.

### EXAMPLE 10

This example illustrates a process for increasing the yield of zeolite product by use of sodium aluminate and nitric acid in place of sulfuric acid.

Zeolite synthesis was carried out as per example 5 except use of sulfuric acid. In place of sulfuric acid 316 grams of nitric acid of 20 wt % concentration was used. Final pH of crystallized product along with mother liquor was measured as 11.9. Oven dried product was weighed as 685 grams having 12 wt % moisture. Zeolite yield has been found increased by 29 wt % compared to yield under reference example 2.

The crystallinity of the product was 87% with unit cell size (UCS) 24.68 Å, surface area 657 m²/g.

Particle size distribution and average particle size (APS) for the obtained product was measured employing laser particle sizer. APS was measured as 5 micron against 3 micron for a product obtained under example 2. Scanning electron micrographs of the product showed clear octahedral morphology for zeolite crystals, having a size of between 3 microns to 7 microns.

### EXAMPLE 11

This example illustrates a process for increasing the yield of zeolite product by use of sodium aluminate and formic acid in place of sulfuric acid.

Zeolite synthesis was carried out as per example 5 except use of sulfuric acid. In place of sulfuric acid 172 grams of 40 wt % formic acid was used. Final reaction mixture's pH was measured as 12.0. Oven dried product was weighed as 674 grams having 12 wt % moisture. Zeolite yield has been found increased by 27 wt % compared to yield under reference example 2.

The crystallinity of the product was 89% with unit cell size (UCS) 24.67 Å, surface area 667 m²/g.

APS of zeolite was measured as 4.5 micron. Scanning electron micrographs of the product showed octahedral morphology zeolite crystals, having a size of between 2 microns to 7 microns.

While comparing the teachings of Example 2 and Example 10, it can be noticed that the average particle size (APS) of the product thus obtained is increasing. Without restricting themselves to any particular reasons or theory for the increase in the average particle size (APS) of the product, it can be said that one of the probable reasons for the increase in the average particle size of the zeolite could have been further growth of the already grown crystals by the addition of the aluminum source at the intermediate stage of crystallization. Once again, without restricting themselves to any particular theory, it can be said that the addition of the aluminum source at the intermediate stage of crystallization is such that it results in the further growth of the already grown crystals and not in the formation of new crystals or in other words, not in the increase in the number of the crystals.

It can be said that the addition of the aluminum source at the intermediate stage of crystallization is such that the number of crystals obtained is restricted through the controlled use of nuclei in the form of seed to the gel mixture. The nuclei of the seed are allowed to grow till all the aluminum present in the reaction mixture gets almost exhausted. Aluminum being more reactive migrates towards nuclei at the faster rate than the silicon and this depletes faster. This has been researched through experimentation by the Inventors. On reaching the stage towards non-availability of aluminum, the crystals usually stop growing.

At this stage, additional calculated quantity of aluminum from source of aluminum selected from sodium aluminate, aluminum oxalate, colloidal alumina or alumina gel is added based on freely available un-reacted silica in the aluminum deficient reaction mixture. Any addition of aluminum at this stage of the reaction could have resulted in decrease in the average particle size of the zeolite crystals because of formation of new nuclei. However, in the present invention, the process is controlled in such a manner that the addition of aluminum at the intermediate stage does not act as fresh (new) nuclei. Due to the above, reason, it is envisaged that the addition of aluminum at the intermediate stage only contributes towards further growth of already grown crystals and thereby increases the crystal size of the resulting zeolite.

We claim:

1. A process for enhancing the yield of molecular sieve zeolite during the synthesis from a sodium aluminosilicate reaction mixture, said process comprising the step of adding at an intermediate stage of crystallization a source of aluminum and an acid to the sodium aluminosilicate reaction mixture and allowing the mixture to crystallize, wherein the adding of the source of aluminum serves to make up for the aluminum deficiency arising in the sodium aluminosilicate reaction mixture during crystallization.

2. A process as claimed in claim 1, wherein the source of aluminum is added to the sodium aluminosilicate reaction mixture over an extended period of time.

3. A process as claimed in claim 1, wherein the source of aluminum is added to the sodium aluminosilicate reaction mixture in a dilute form.

4. A process as claimed in claim 1, wherein alumina is present in the ionic form in the source of alumina.

5. A process as claimed in claim 1, wherein the source of aluminum is added to the sodium aluminosilicate reaction mixture under constant agitation.

6. A process as claimed in claim 1, wherein the sodium aluminosilicate reaction mixture is depleted of aluminum and enriched in un-reacted soda and silica at the intermediate stage of crystallization.

7. A process as claimed in claim 1, wherein the intermediate stage of crystallization at which aluminum source and the acid is added occurs in the range of 0.5 hour to 48 hours.

8. A process as claimed in claim 1, wherein the molecular sieve zeolite obtained is selected from the group consisting of low silica to alumina ratio zeolite, a medium silica to alumina ratio zeolite and a high silica to alumina ratio zeolite.

9. A process as claimed in claim 1, wherein the molecular sieve zeolite obtained is selected from zeolite Y, X, A, ZSM-5, ZSM-11, Beta, Omega, climnoptilote and Mordenite.

10. A process as claimed in claim 1, wherein the source of aluminum is selected from the group consisting of aluminum salts, bayerite, pseudoboehmite, alumina gel and alumina sol and the acid is selected from the group consisting of sulfuric acid, nitric acid, hydrochloric acid, hydrofluoric acid, formic acid, acetic acid, citric acid, and oxalic acid.

11. A process as claimed in claim 10, wherein the aluminum salt is selected from the group consisting of aluminum sulfate, sodium aluminate, aluminum oxalate, aluminum formate, and aluminum trihydrate.

12. A process for enhancing yield of molecular sieve zeolite during synthesis from a sodium aluminosilicate reaction mixture, said process comprising steps of:
(a) preparing a sodium aluminosilicate seed mixture;
(b) preparing a sodium aluminosilicate gel reaction mixture;
(c) adding the seed mixture of step (a) to the gel reaction mixture of step (b) to obtain molecular sieve precursor mixture;
(d) heating the molecular sieve precursor mixture to a temperature sufficient for crystallization to occur;
(e) adding a source of aluminum and an acid to the molecular sieve precursor mixture at an intermediate stage of crystallization, wherein the molecular sieve precursor mixture is depleted of aluminum and enriched in soda and silica at the intermediate stage wherein the adding of the source of aluminum serves to make up for the aluminum deficiency arising in the molecular sieve precursor mixture during crystallization, and (f) crystallizing molecular sieve zeolite product, recovering of crystallized product by filtration; washing the same with hot demineralised water to obtain molecular sieve zeolite with pH below 9.

13. A process as claimed in claim 12, wherein the molecular sieves are selected from the group consisting of zeolite A, X, Y, Mordenite, Beta, Omega, climnoptilote , ZSM-5 and those having sodium aluminosilicate framework can be enhanced by addition of aluminum source and an acid during intermediate stage of crystallization.

14. A process as claimed in claim 12, wherein precursor gel mixture has wide range of composition expressed in the molar ratio as:
0.5-15 Na₂O:Al₂O₃:1-200 SiO₂:50-1000 H₂O.

15. A process as claimed in claim 12, wherein the crystallizing molecular sieve zeolite product occurs in from 24 hrs to 120 hrs.

16. A process as claimed in claim 12, wherein the crystallizing molecular sieve zeolite product occurs at a temperature that varies from 45 to 180° C.

17. A process as claimed in claim 12, wherein the source of aluminum is selected from group consisting of aluminum sulfate, sodium aluminate, aluminum oxalate, aluminum formate, aluminum trihydrate, colloidal alumina and alumina gel.

18. A process as claimed in claim 12, wherein the quantity of aluminum compound added at intermediate stage of crystallization is in the range of 0.5 to 25 wt % expressed as Al₂O₃ on the basis of total silica (SiO₂) present in the precursor gel mixture.

19. A process as claimed in claim 12, wherein the acid used is selected from the group consisting of sulfuric acid, nitric acid, hydrochloric acid, hydrofluoric acid, formic acid, acetic acid, citric acid, and oxalic acid.
